(19) United States
(12) Patent Application Publication
(10) Pub. No.: US 2019/0370705 A1
(43) Pub. Date: Dec. 5, 2019

(54) Methods and tools to mitigate financial crashes and advantage financial rallies

(71) Applicant: Jerome Lawrence Kreuser, Arlington, VA (US)

(72) Inventor: Jerome Lawrence Kreuser, Arlington, VA (US)

(21) Appl. No.: 16/426,840

(22) Filed: May 30, 2019

Related U.S. Application Data
(60) Provisional application No. 62/680,476, filed on Jun. 4, 2018.

(51) Int. Cl. G06Q 10/04; G06Q 40/00

(52) U.S. Cl. CPC G06Q 10/04; G06Q 40/00

(57) ABSTRACT

Methods and systems for processing data classes including asset prices, liability prices, economic prices, economic indicators, and related time series to estimate future changes in said data especially including jumps and extreme changes in said data and to provide information on how to hedge against said jumps in a downward direction and to advantage said jumps in an upward direction. Said data is received as input. In order to estimate the probability and size of future said jumps we propose their analysis through a dynamic Rational Expectations (RE) bubble model of prices with the intention to exploit it for and evaluate it on optimal investment strategies. Our bubble model is defined as a geometric random walk combined with separate crash (and rally) discrete jump distributions associated with positive (and negative) bubbles. Said jumps may be sudden or over a longer period of time. We assume that jumps tend to efficiently bring back excess bubble prices close to a “normal” or fundamental value (“efficient crashes”). Then, the RE condition implies that the excess risk premium of the risky asset exposed to crashes is an increasing function of the amplitude of the expected crash, which itself grows with the bubble mispricing: hence, the larger the bubble price, the larger its subsequent growth rate. Our bubble model also allows for a sequence of small jumps or long-term corrections. We apply said bubble model to the optimal investment problem by obtaining an analytic expression for allocating among said data classes to substantially outperform other methods of allocation to said data classes.

### RELATED US APPLICATION DATA

Provisional Patent Application Ser. No. 62/680,476, entitled “Methods and tools to mitigate financial crashes and advantage financial rallies.” which was filed on Jun. 4, 2018.

### PUBLICATION CLASSIFICATION

G06Q10/04

G06Q10/063

G06Q10/0635

G06Q40/06

G06Q40/08

### CROSS-REFERENCE TO PROVISIONAL APPLICATION

This application claims priority under 35 U.S.C. 119(e) to U.S. Provisional Patent Application Ser. No. 62/680,476, entitled “Methods and tools to mitigate financial crashes and advantage financial rallies.” which was filed on Jun. 4, 2018, the disclosure of which is incorporated herein by reference in its entirety.

### BACKGROUND

The last financial crisis in 2007 to 2009 revealed serious flaws in economic modelling and in the use of mathematical and engineering models in finance, in particular with respect to the occurrence of bubbles, crashes and crises. The methods and systems herein contribute to enriching the understanding of financial markets by proposing a simple bubble and crash model, which can be calibrated and made operational in portfolio investments. The model stresses the importance of positive feedbacks, the tendency for financial markets to self-correct only at long time scales (years to decades) while exhibiting significant departure from “normality” at short times (day, months and even years).

In academia, discussion on financial bubbles often start with a reference to the Efficient Market Hypothesis (EMH), which in essence states that prices of financial assets properly reflect underlying economic fundamentals. Financial bubbles and the crashes that frequently follow them are arguably the most vivid challenge to the EMH. Here, we define a bubble as a period of unsustainable growth when the price of an asset increases ever more quickly in a way not justified by fundamental valuation. A strand of literature has thus developed to detect deviations from the elusive fundamental value, with an extensive econometric literature on the identification of bubbles, see e.g. (Homm and Breitung, 2012; Phillips et al., 2015; Vogel and Werner, 2015). Another branch of the literature has been concerned with the possible generating mechanisms, in particular addressing the paradoxes posed by the apparent arbitrage opportunities provided by persistent overpricing during bubble regimes, see e.g. the reviews (Kaizoji and Sornette, 2010; Brunnermeier and Oehmke, 2013; Xiong, 2013). The methods and systems herein focus on the second part concerned with the development of a suitable theoretical framework to model financial bubbles, which can be exploited to develop crash- and rally-aware optimal portfolios.

The methods and systems differ substantially from other methods and systems applied to bubble models. Some of the main concepts that are needed to understand the behavior of financial markets are social imitation, herding, self-organized cooperativity and positive feedbacks, which leads to super-exponential, unsustainable growth of the price process (Johansen et al., 1999; 2000; Sornette, 2003; 2014; Johansen and Sornette, 2010; Jiang et al., 2010; Sornette and Cauwels, 2015]. We note that super exponential growth during a bubble has been confirmed in a model-independent analysis of real stock market data (Leiss et al., 2015) as well as in price formation experiments (Hüsler et al., 2013).

The study of bubbles (rational expectations or not) has tended to focus on two aspects; the investment problem and the financial economic implications, see Davis and Lleo (2013a). We combine both aspects in our unique bubble model. It is in the context of evaluating our bubble model performance in optimal investment in mitigating crashes and taking advantage of rallies and explaining how bubbles begin and end.

What we do different from Davis and Lleo is that we combine our bubble model with differing jump distributions for crashes and for rallies relative to a normal price and we allow the distributions to change over time depending on the acceleration in the price data. The jump distributions in Davis and Lleo are independent of a bubble model and their model is in continuous time.

Bubble models have classically considered prices and dividends. Then a bubble is defined as when an asset's price exceeds the discounted value of future expected cash flows, which can be prices plus dividends. However, in our bubble model, we assume total returns and similarly in historical price time series. In our bubble model, when the average normal price rate converges to the discount rate, our current price is always the discounted value of the expected future price and the average expected return on the bubble component converges to zero. Therefore, we do not have the usual difficulties in rational expectations bubble models requiring the bubble component being exactly equal to the asset's required rate of return or issues in an upper bound on the price. See for example, Scherbina, 2013.

### BRIEF SUMMARY

With this background, our bubble model includes the following important properties:
1. It is a Rational Expectations model.
2. Prices temporarily deviate from a fundamental value or “normal price” process.
3. It is mildly explosive when the crash/rally probabilities are taken as average.
4. It can become super-exponential, following a path that would end with finite time singularities when probabilities are computed dynamically in a positive or negative bubble. The presence of crashes prevents actually reaching the finite-time singularities.
5. It never stops even on negative bubbles.
6. The price stochastically oscillates around a normal price until it randomly begins to grow or decline and then accelerate to a bubble (positive or negative).

It also includes the following secondary properties:
1. The price growth converges in the limit to that of the normal price process.
2. As a consequence of the crashes and rallies together with the transient super-exponential phases, the price oscillates between positive and negative bubbles.
3. There is no upper or lower bound on the log of the price.
4. It combines a geometric random walk with a discrete Poisson distribution of crashes/rallies.
5. The crash/rally distribution sizes allow for over- and under-shooting the normal price.
6. Prices never become infinite as the crash probability becomes one before that happens.
7. It shows how bubbles can be spontaneously initiated and terminated.
8. It can be tested empirically by implementing an optimal investment method, which demonstrates a superior bubble mitigation performance.
9. It is arbitrage free.

In this model, a bubble begins because a random fluctuation has a large enough deviation from a normal price to throw it into bubble state whereby it may continue to accelerate because, in the presence of positive feedback, it takes larger correcting random fluctuations to bring the price sufficiently back down. This idea of a random fluctuation is conceptually similar to the mechanism put forward by Harras and Sornette (2011) in which bubbles originate from a random lucky streak of positive news that, due to a feedback mechanism of these news on the agents' strategies, develop into a transient collective herding regime.

Our bubble model suggests that investment in the bubble is rational given the expectation that players can sell off at a higher price in the future before the bubble bursts. Yet, some players may get out as the probability increases beyond their risk threshold resulting in a plateau of prices before bursting. The phenomena of acceleration and plateau are those that we capture in our bubble model.

### BRIEF DESCRIPTION OF DRAWINGS

Our method is a computer implementation of a mathematical approach to determine the existence of possible crashes including their magnitude, probability, timing and to provide ways to mitigate crashes and advantage rallies. There are no limitations to the computers the method can run on or the languages the method can be programmed in.

We include herein three ways the method can operate:
1. Through a control panel (E.g. FIG. 5) with one set of price data with user control over all parameters and several diverse kinds of outputs. We in no way limit the structure and type of control panel to that exampled in FIG. 5.
2. Through a control panel with several price data vectors each with individual metadata describing some of the parameters used in the method. An example of an embodiment of data for this method of operation is given in FIG. 7.
3. By itself automatically in the background based upon a preset schedule accessing the data and parameters required or by recomputing the necessary parameters.

While I have shown in the accompanying drawings an embodiment of my invention, it is to be understood that the same is susceptible of modification and change without departing from the spirit of my invention.

The spirit is captured in the method flowcharts as depicted in FIGS. 1, 2, 3, and 4. It is understood that the flowcharts are susceptible to modification and change without departing from the spirit of the invention.

The embodiment in FIG. 1 contains the following components:
1. Inputs that can be entered by executives consisting of wisdom;
2. A database containing the most recent market and economic data;
3. External risk managers and advisors that input expert wisdom;
4. Other external feeds consisting of relevant information for the method including implied prices, various economic or mathematical theories, any changes in financial or economic regimes identified;
5. Historical price data is analyzed for consistency and other factors;
6. The normal price is estimated;
7. The historical jump size distribution is estimated;
8. The crash or rally probabilities are estimated in those circumstances when the prices are accelerating;
9. The asset allocations are calculated;
10. Marginal returns and zero-sum adjustments to the portfolio are estimated;
11. Various outputs, tables, graphs, distributions, etc. are generated.

Examples of the types of outputs that may be generated are given in FIGS. 8, 9, and 10.

FIG. 2 shows a simplified version of the computational flow.

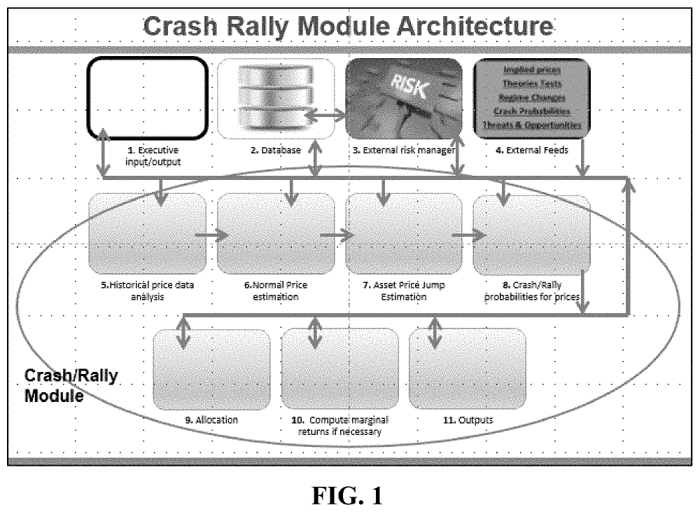

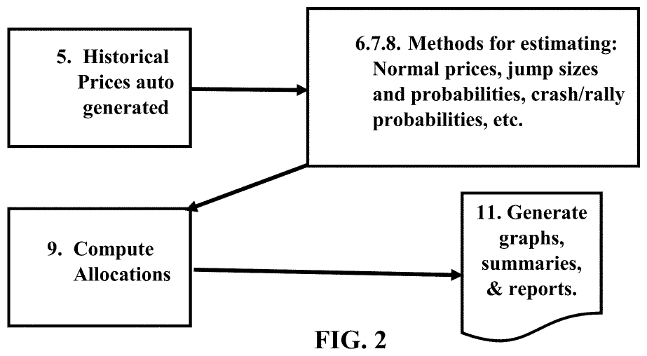

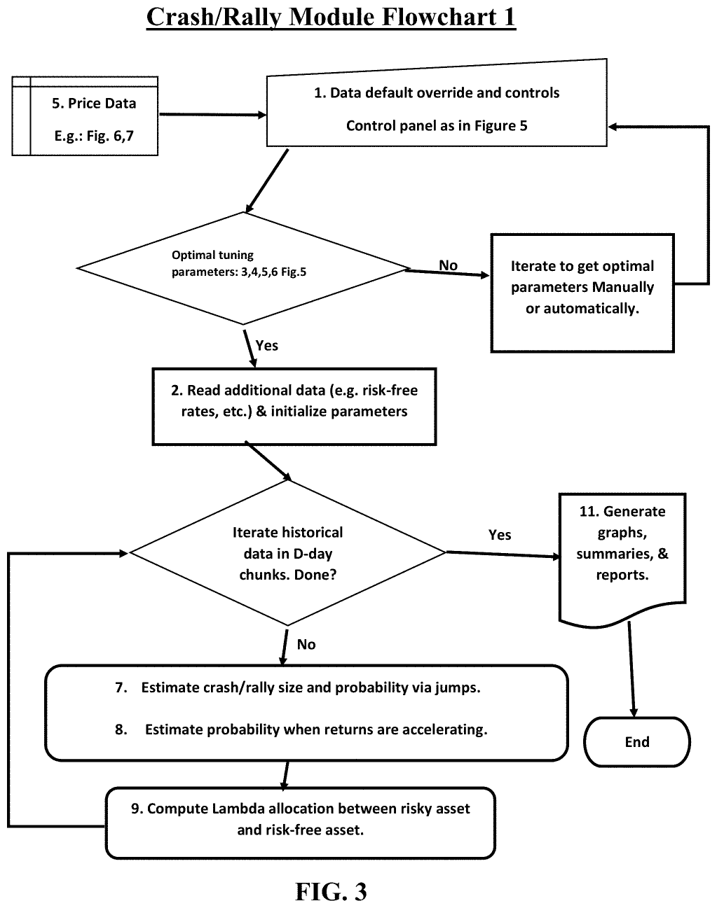

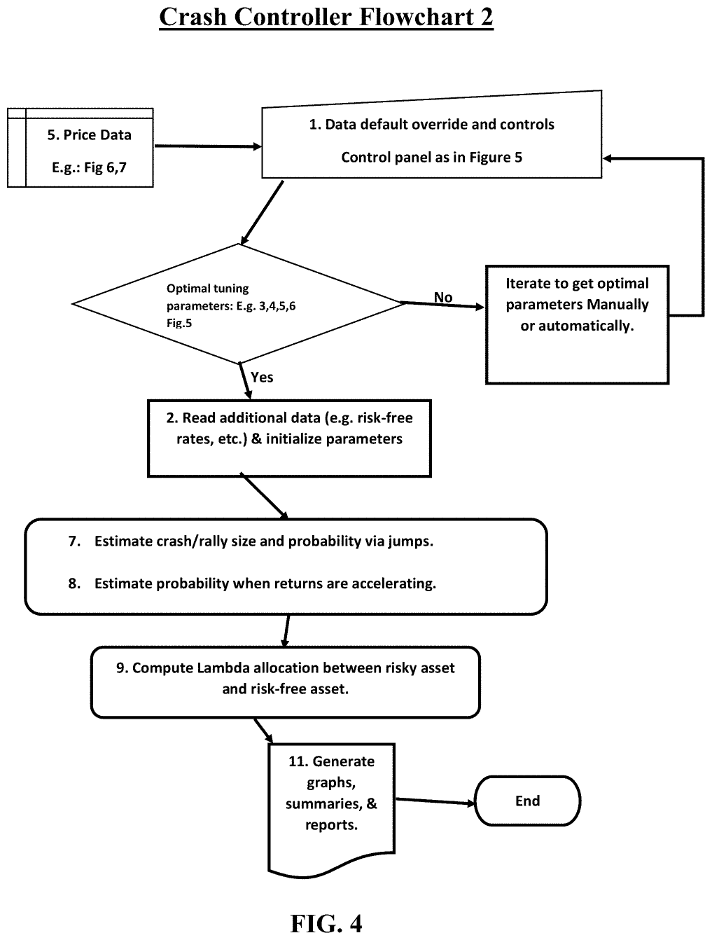

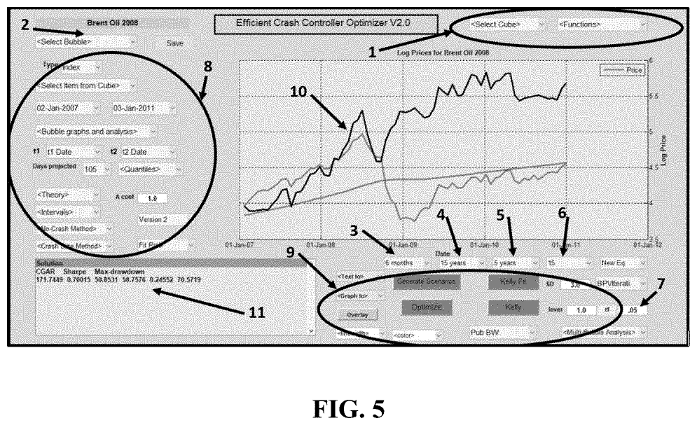

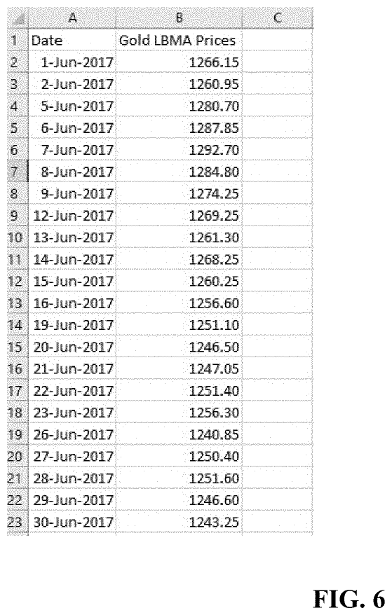

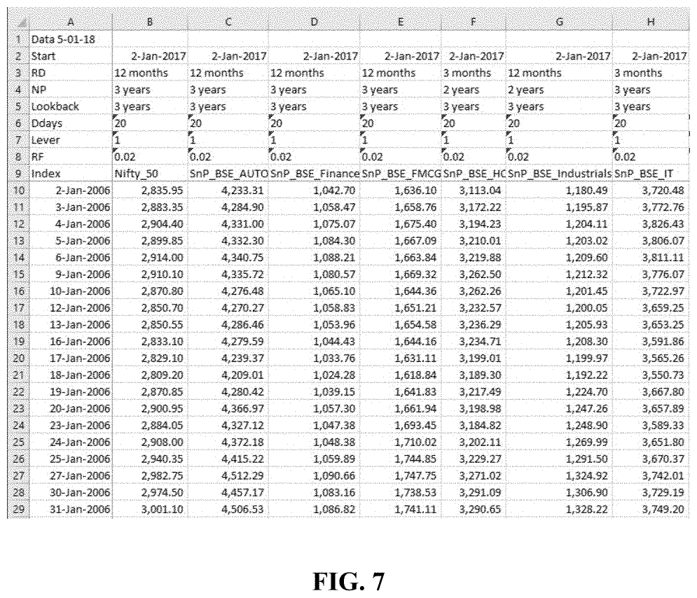

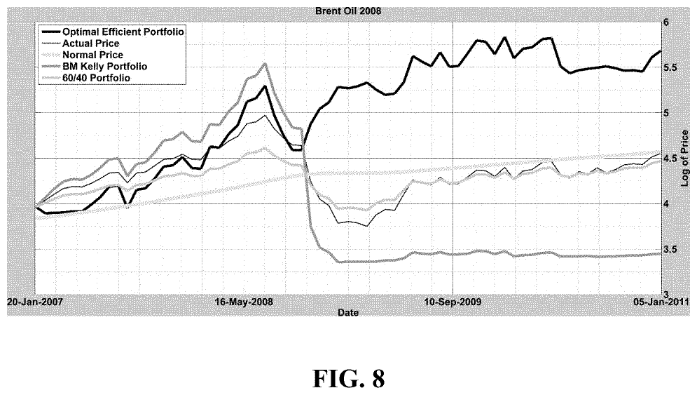

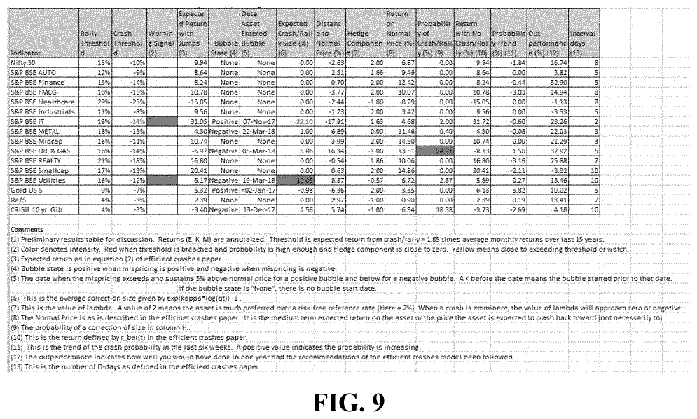

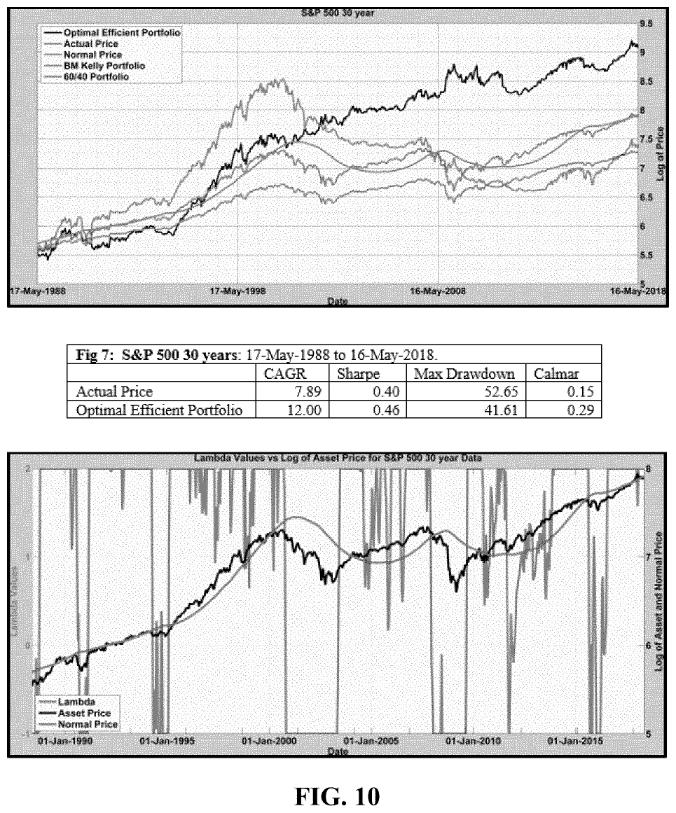

The flowchart in FIG. 3 gives the details wherein the method is back tested through history whereby the parameters are chosen optimally by running the method with various parameter values throughout history and selecting those parameters values that give the best performance.
5: Input raw price data. For example, it may come from an Excel spreadsheet (FIG. 2) or form any database system.
1: Default setting may be overridden by the user as desired.
Are the tuning parameters optimal? The tuning parameters are optimal when the result over a period of history shows out-performance as in FIG. 3. These tuning parameters are;
   The numbers of months of historical data used to calculate the discount rate of the asset price (FIG. 8);
   The number of months of historical data used to calculate the normal price (FIG. 8);
   The number of months of historical data to calculate the separation between jumps and the random walk (FIG. 11); and
   The size of the discrete time interval (FIG. 7).
Different combinations of the tuning parameters are tested until the best out-performance is obtained.
2: Any additional data is read in such as the risk-free rate historically and any other parameter setting useful in running the method.
Iterate through a period of history in D-day chunks where D-day is the number of days in the discrete time interval mentioned in 3.
11: When we are done, generate the final graphs (example in FIG. 3), any reports, and information on probabilities, size, timing, and expected returns for a crash or rally. Such summary reports may be but are not required to be like those in FIG. 6.
7: Calculate the estimated crash/rally size and probabilities using the method of separating jumps form random walks as depicted in FIG. 11. FIG. 11 is a sample embodiment of a method to separate jumps from random walks, yet it is to be understood that the same is susceptible of modification and change without departing from the spirit of my invention.
8: Estimates the probability when returns are accelerating. FIG. 12 is a sample embodiment of a method to calculate the dynamic probability, yet it is to be understood that the same is susceptible of modification and change without departing from the spirit of my invention.
9: Computes the allocation between the asset and the risk-free rate to provide the best return as depicted by lambda in FIG. 10. The lambda may be computed as per FIG. 10 by optimizing the equation (12) or by using an estimated value for lambda as depicted in Proposition 4.

FIG. 4 shows the flowchart of the method with computations for allocations done only at the one day, which is normally assumed to be the day the estimations of crash or rally information is to be estimated; e.g. today.

The following is the list of figures:

FIG. 1: A crash rally system architecture.

FIG. 2: A flowchart of the method for running automatically with precalculated parameters.

FIG. 3: A detailed flowchart whereby method iterates through historical data.

FIG. 4: A detailed flowchart whereby method assumes parameters are known.

FIG. 5: An example of a control panel used in respect to the flowchart in FIG. 4. The elements of the FIG. 5 are described in the following:
1: Input selection controls to read in raw data and convert to the condensed data form used in the Efficient Crash Controller
2: Select a set of asset data.
3: Select the size of the historical data used to compute the short-term-rate or “discount” rate.
4: Select the size of the historical data used to compute the “normal price”.
5: Select the size of the historical data used to separate jumps in asset prices to compute initial expected jump sizes and probabilities.
6: Select the number of D-days to be used in computing the interval jump sizes and probabilities.
7: Select the average risk-free rate or read the rate in from historical data.
8: Various options to print graphs of historical data, select window estimation size, and to print out various parameters.
9: Options to print graphs and other information results and to generate results (“Kelly” button).
10: A graph generated from the method showing the out-performance of the method, the asset price graph, and the normal price.
11: Various outputs from the method containing, for example, CGAR, Sharpe Ratio, and maximum draw-down for the efficient portfolio as compared t the asset.

FIG. 6: An example of a snippet of price data for input to the method.

FIG. 7: An example of a snippet of multiple price data with specified parameters for input to the method.

FIG. 8: An example of a graphical output from the method illustrating the price paths for the asset and for other combinations of the asset and an allocation obtained from the method consisting of the asset plus another asset herein a risk-free asset.

FIG. 9: An example of a tabular output for several assets including computed elements of the method.

FIG. 10: Another example of a graphical output from the method illustrating the price paths for the asset and for other combinations of the asset and an allocation obtained from the method consisting of the asset plus another asset herein a risk-free asset along with the graphical output of the allocation factor, lambda, giving the values of the allocation parameter over time, along with a table summarizing some properties of the asset price and the price of the portfolio consisting of the allocation of the asset and the risk-free rate here. The method also generates comparable outputs for combinations of any number of assets.

### DETAILED DESCRIPTION

The particular values and configurations discussed in the following non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and willfully convey the scope of the invention to those skilled in the art. Like numbers refer to like elements throughout. As used herein, the term “and/or includes any and all combinations of one or more of the associated listed items.

The terminology used herein is for the purpose of describing particular embodiments only and is not intended to be limiting of the invention. As used herein, the singular forms “a”, “an’, and “the are intended to include the plural forms as well, unless the context clearly indicates otherwise. It will be further understood that the terms “comprises’ and/or “comprising, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and Scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Examples of terms used herein can be found in Kreuser And Sornette, 2018, but are not meant to be limited to that technical paper.

As can be appreciated by one skilled in the art, embodiments can be implemented in the context of a method, data processing system, and/or computer program product. Accordingly, embodiments may take the form of an entire hardware embodiment, an entire software embodiment, or an embodiment combining software and hardware aspects all generally referred to herein as a “method” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD ROMs, optical storage devices, magnetic storage devices, server storage, databases, cloud storage etc.

Computer program code for carrying out operations of the present invention may be written in an object-oriented programming language (e.g., Java, C++, Python, etc.). The computer program code, however, for carrying out operations of particular embodiments may also be written in conventional procedural programming languages, such as the “C” programming language or in a Visually oriented programming environment, such as, for example, Visual Basic, or in a modeling language such as GAMS and solvers associated to GAMS such as CPLEX or CONOPT but not to be limited to such solvers.

The program code may execute entirely on the user's computer, partly on the user's computer, as a standalone software package, partly on the user's computer and partly on a remote computer, or entirely on the remote computer oar cloud computer. In the latter scenario, the remote computer may be connected to a user's computer through a local area network (LAN) or a wide area network (WAN), wireless data network e.g., WiFi, Wimax, 802.XX, and cellular network or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of information including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process Such that the instructions which execute on the computer or other programmable apparatus provide steps for implementing the functions/acts specified in the block or blocks.

FIGS. 1-4 are provided as exemplary diagrams of data-processing environments in which embodiments may be implemented. It should be appreciated that FIGS. 1-4 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

### Exemplary Method for Model Equations

The particular values and configurations discussed in these non-limiting examples can be varied and are cited merely to illustrate at least one embodiment and are not intended to limit the scope thereof. In the following we describe an example of an embodiment of the set of equations describing the interaction between price data, price movements, and price jumps, which may be referred to as crashes if the jump down is sufficiently large and quick and a rally if the jump up is sufficiently large and quick.

We define the following set of variables:

Δt=discrete time interval [t,t++1].

pₜ=price of the risky asset at time t.

r̅ᵢ=expected return of the risky asset on Δt when there is no crash or rally.

σ=standard deviation on Δt of the geometric random walk price process.

εₜ=sample from a standard normal distribution at time t.

r_{D}=discount rate of the asset price on Δt.

r_{N}=growth rate of the “normal price” on Δt.

r_{f}=risk-free rate on Δt.

p₀=starting price of the risky asset.

Nₜ=p₀ exp(r_{N}t): this defines the normal price process.

ρₜ=probability that there is a correction (crash or rally) at time t.

κᵢ∈(−∞,∞)=the size of the i^{th} corrective jump relative to the distance to the normal price. We refer to it as the “crash factor”.

ηᵢ=probability that, when there is a correction, it is of size κᵢ.

$$\overline{K} ≡ {\sum }_{i = 1}^{n} {η}_{i} {κ}_{i} = expected corrective crash size relative to the distance to the normal price or expected crash factor . \\ {q}_{t} = \frac{{N}_{t}}{{p}_{t}} is the relative ( negative ) mispricing of the risky asset .$$

We introduce the simple stochastic price process with a discrete Poisson process.

$${p}_{t + 1} = {p}_{t} exp ( {\overline{a}}_{t} + σ {ɛ}_{t} ) \\ with {p}_{0} > 0 and \\ {\overline{a}}_{t} = \{ \begin{matrix}\begin{matrix} {\overline{r}}_{t} with probability 1 - {ρ}_{t} with 0 \leq {ρ}_{t} < 1 \\ {κ}_{i} ln ( {q}_{t} ) + {r}_{D} with probability {ρ}_{t} {η}_{i} i = 1 , 2 , … , n\end{matrix} \\ {κ}_{i} ∈ Ω ≡ \{ {κ}_{i} \vert - ∞ < {κ}_{i} < ∞ , i = 1 , 2 , … , n \}\end{matrix} \\ with \\ {q}_{t} = \frac{{N}_{t}}{{p}_{t}} and {\sum }_{i = 1}^{n} {η}_{i} = 1 \\ 0 < {η}_{i} < 1 and \overline{K} = {\sum }_{i = 1}^{n} {η}_{i} {κ}_{i} \\ {N}_{t} = {p}_{o} exp ( {r}_{N} t ) \qquad ( 1 )$$

The crash factors are assumed independent and constant over time and distributed according to the probability distribution Π{ηᵢ=Pr[crash amplitude=κᵢ]|i=1, 2, . . . , n}. Thus, conditional on no crash happening, which holds at each time step with probability 1−ρ̅, the price pₜ follows a geometric random walk with mean return r̅ₜ on Δt and volatility σ. We assume that σ is constant, although it is not a necessary condition. At each time step, there is a probability ρ̅ for a crash/rally to happen with an amplitude that is proportional to the bubble size, or amplitude defined as

$$ln ( {q}_{t} ) = ln ( \frac{{N}_{t}}{{p}_{t}} )$$

where Nₜ=p₀ exp(r_{N}t) and r_{N} is defined as the long-term average return.

For simplicity of exposition, we will often use a single crash factor, K̅, and crash probability ρ̅

In the simplest incarnation of the model, the rates r_{D} and r_{N} are constant. When we apply our model to real data, we will want to assume that they vary over time and then characterize them as r_{D,t} and r_{N,t}. In this case, we will assume that both r_{N} and r_{D} vary with time and that r_{N} varies slowly while r_{D} varies more rapidly over time. We may also consider r_{D} as varying about r_{N}. When they vary over time, we will want

$${lim}_{t \to ∞} \frac{1}{t} {\sum }_{τ = 1}^{t} ( {r}_{N , τ} - {r}_{D , τ} ) = 0.$$

A positive κᵢ with a qₜ<1 means the risky asset is in a positive bubble with a potential correction relative to Nₜ of size κᵢ. A negative κᵢ with qₜ>1 means that the risky asset is in a regime of transient under-valuation, where the price progressively accelerates downward and will eventually rebound in a rally jump of positive size κᵢ times the mispricing amplitude to get closer to the normal price process. The price process model defined by (1) holds for positive (ln(qₜ)<0) and negative (ln(qₜ)>0) bubbles. We allow κᵢ to have any real value so that we could replace the discrete jump distribution by a continuous one. In general, and in applications to actual price processes, we will assume that there is a separate distribution Π⁺ for positive and Π⁻ for negative bubbles, consistent with empirical observations.

To see clearly what āₜ=κᵢ ln(qₜ)+r_{D} means, suppose Kᵢ=1. Our price process is such that the crash or recovery is instantaneous and occurs at the beginning of the discrete time interval Δt. Then the occurrence of the crash at time t leads to the price going from pₜ to the exact value of the normal price Nₜ=p₀ exp(r_{N}t) and continuing on the interval Δt to Pₜ₊₁ at the rate r_{D}. The price thus changes instantaneously with magnitude exp (κᵢ ln(qₜ)) at time t and continues changing by exp(r_{D}) over the interval. In other words, pₜ₊₁=Nₜ exp(r_{D}). The price Nₜ thus acts as a reference price to which the price pₜ tends to revert intermittently via the crash occurrences. We assume that the crash probability is independent and constant over time: Eₜ₋₁[ρₜ]=E[ρₜ]≡ρ̅:We will relax this assumption later and make it dynamic.

We refer to this specification as corresponding to “efficient crashes”, in the sense that their amplitudes are proportional to the bubble size ln(qₜ), as opposed to being independent of the mispricing. Thus, the more the bubble booms above or below the average fundamental process, the larger the next crash or rally, which will thus tend to bring back the price ρₜ towards Nₜ, as argued by Fama (1988) in his analysis of the October 1987 crash. As we will show, this also ensures that, notwithstanding the presence of large bubbles, the price process remains co-integrated with the normal price process on the long term.

Our bubble model does not require one large jump to correct to the normal price. Because of the distribution Π, it can be a sequence of small jumps. It can also be a slower long-term correction depending on the evaluation of r_{D} after a correction commences.

We assume now that the expected return r̅ₜ̅ is determined in accordance with the Rational Expectation condition

$${E}_{t} ( ln ( \frac{{p}_{t + 1}}{{p}_{t}} ) ) = {r}_{D} ∀ t ,$$

which reads

$$\begin{matrix}{E}_{t} [ ln ( \frac{{p}_{t + 1}}{{p}_{t}} ) ] = ( 1 - \overline{ρ} ) {\overline{r}}_{t} + \overline{ρ} ( {\sum }_{i = 1}^{n} {η}_{i} {κ}_{i} ) ln ( {q}_{t} ) + \overline{ρ} {r}_{D} \\ = ( 1 - \overline{ρ} ) {\overline{r}}_{t} = \overline{ρ} \overline{K} ln ( \frac{{N}_{t}}{{p}_{i}} ) + \overline{ρ} {r}_{D} \\ = {r}_{D}\end{matrix} \qquad ( 2 )$$

where K̅ is the expected crash factor. With the RE equation, the value r̅ₜ̅ of the expected return of the risk asset is:

$$\overline{{r}_{t}} = {r}_{D} - \frac{\overline{ρ} \overline{K} ln ( {q}_{t} )}{1 - \overline{ρ}} \qquad ( 3 )$$

If there is never a crash (ρ̅=0), then the expected return of the risk asset is always r_{D}.

### Exemplary Method for Providing a Predetermined History

The particular values and configurations discussed in these non-limiting examples can be varied and are cited merely to illustrate at least one embodiment and are not intended to limit the scope thereof. A predetermined history is generally considered to but not limited to a period of history where the stochastic processes have been relatively stable.

### Exemplary Method to Estimate a Normal Price

The particular values and configurations discussed in these non-limiting examples can be varied and are cited merely to illustrate at least one embodiment and are not intended to limit the scope thereof.

It can happen that a negative bubble occurs when transiently q<1 or a positive bubble when q>1. If a jump related to the bubble is large enough, we can assume that the jump is to a new normal price. We then redefine the start of our new normal price Nₜ_{₁}=pₜ_{₁}. We will investigate this further in a subsequent empirical study.

The discount rate r_{D} is estimated over a time window less than the window used to calculate the normal price. We estimate them so that we have approximately

$${lim}_{t \to ∞} \frac{1}{t} {\sum }_{τ = 1}^{t} ( {r}_{N , τ} - {r}_{D , τ} ) = 0.$$

We can get a reasonable estimate directly on the expected return, r̅ₜ̅, especially when the crash probability, ρₜ, is large as this signals an accelerating return.

A normal price is generally estimated over a limited but long period of history where the stochastic processes have been relatively stable by fitting the data with an exponential estimation.

### Exemplary Method to Estimate Asset Price Jumps and Probabilities

The particular values and configurations discussed in these non-limiting examples can be varied and are cited merely to illustrate at least one embodiment and are not intended to limit the scope thereof.

To test and apply our model on real data, we need to estimate several parameters including ρ̅, K̅, r_{N}, r_{D} and σ. We first focus on estimating K̅, σ, and ρ̅. The idea is to separate the geometric random walk from jumps in the historical data. When we do that, we will separate out σ, meaning that a correct estimation of the model makes the “true” σ associated with the underlying geometric random walk component smaller than the apparent σ computed directly from the historical data without awareness that jumps are present.

A promising approach is to use realized variation and bi-power variation. General assumptions for their application include:
1. Independence of jumps and r̅ₜ.
2. General assumptions are that the jump sizes form a normal distribution, but this can be relaxed.
3. Jumps are independent of the log-price. This may be true, but they may be dependent upon mispricing.
4. There is at most one large jump per day.

Huang and Tauchen (2005) design a significance test based on a relative difference for jumps using a parameter z_{t-h,t}, called the z-test, which converges to a normal distribution as the sampling frequency goes to infinity. The z-test is said to perform impressively when computed daily and does an outstanding job of identifying the days when jumps occur. Tauchen and Zhou (2011) suggest that, after filtering out jumps, a more flexible dynamic structure of the underlying jump arrival rate and jump size distribution can be obtained. See also (Ait-Sahalia and Jacod 2012). Much of the work in this area is on intra-day jumps. Anderson, Bollershev, and Diebold (2007) compute a significant jump and prevent possible negative values in computing the difference between the realized variation and the bi-power variation, which is not possible. This provides a means of selecting “significant” jumps daily based on a α % significance level. These generally rely on intraday data to compute the jumps.

We will be working with daily data and estimating the probability of a jump and jump size over an interval of d-days with d typically between 5 to 15 business days. The choice of d depends on the size and frequency of jumps. When more jumps are present, and the frequency is changing, a shorter size interval is used, whereas when jumps are milder, a longer size closer to 15 days is used. The interval size d will be projected into the future to determine an estimated probability and jump size on that interval consistent with our bubble model of equation (1). We take a window of typically 5 years and partition it into intervals of d-days. For each of these intervals, we will estimate the realized variance (total variation) and the bi-power variation (variation that is not jumps). We will then use these estimates to obtain an average jump size on a d-day interval in the given time window of 5 years. The choice of duration of the time window can however vary around 5 years and reflects the desire to have statistics that are relatively invariant.

We follow the basics of Jacquier and Okou (2014) in our design. We used realized variance composed of continuous volatility and with the jump component embedded in the quadratic variation. They design a statistic based upon the studentized relative difference to test for jumps. This is less useful here as we want to obtain the jump size relative to a variation between the asset price and the normal price. Therefore, we want to know when a variation, rᵢ, can be considered a jump within a specified significance level.

Instead we may use the method of Audrino and Hu (2016) to test if rᵢ is a jump. Whereas they use intraday data, we apply their method to daily data. Let the history from time t be divided into intervals of d days and let there be h such intervals so that the total number of days of history is n=hd. The time t is the time for which we wish to determine if the next interval of d days will contain a jump. We measure the jumps in each of the h intervals of d days. We use their statistic where the denominator contains the spot volatility and k is taken to be 60¹ days and compute L_{t,j} for each rᵢ in each of the prior 60 days. ¹ We use 60 days based on testing giving reasonable results.

$${L}_{t , i} = \frac{{r}_{i}}{\sqrt{\frac{1}{k - 1} {\sum }_{j = 1}^{k - 1} \vert {r}_{t - j} \vert \vert {r}_{t - j + 1} \vert}} \qquad ( 4 )$$

Then |L_{t,i}| converges to a Gumbel distribution as the sampling frequency tends to zero or, as in Audrino and Hu (2016) we have

$${max}_{t , i} \frac{\vert {L}_{t , i} \vert - {C}_{d}}{{S}_{d}} \to G .$$

Therefore rᵢ is taken to be a jump if

$$\frac{\vert {L}_{t , i} \vert - {C}_{d}}{{S}_{d}} > {β}^{*} \qquad ( 5 )$$

where d is the number of days in an interval and S_{d}, C_{d}, and β* are parameters from a standard Gumbel distribution:

$${S}_{d} = \sqrt{\frac{π}{2}} \frac{1}{\sqrt{2 log ( d )}} , \\ {C}_{d} = \sqrt{\frac{π}{2}} [ \sqrt{2 log ( d )} - \frac{log ( π ) + log ( log ( d ) )}{2 \sqrt{2 log ( d )}} ] ,$$

and the significance level is 1−exp(−β*).

We say that rᵢ is a jump if (6) is satisfied and define

$${I}_{t , i} = \{ \begin{matrix}1 & if \frac{\vert {L}_{t , i} \vert - {C}_{d}}{{S}_{d}} > {β}^{*} \\ 0 & otherwise\end{matrix} \qquad ( 6 )$$

We define jumps relative to t and the h intervals of size d-days. We define the indices for the lth interval as IDₗ={i|t−1d+1≤i≤t−(l−1)d for l=1, 2, . . . , h} and so, as mentioned above, we divide the n days into h intervals of d days. We associate a value

$${q}_{l} = \frac{{N}_{l}}{{p}_{l}}$$

to an interval where qₗ=q_{τ} for τ=t−ld−1. That is, qₗ corresponds to the value of q_{τ} for the time τ prior to the beginning of the lth interval. That is the point by which we determine the asset price relative to the normal price to decide if the jumps in the next interval are for a positive or a negative bubble.

We define positive (JP) and negative (JN) bubble jumps by interval as:

$${JP}_{l} = {\sum }_{i ∈ {ID}_{l}} {r}_{i} {I}_{t , i} if log ( {q}_{l} ) < - δ for some δ > 0 and \\ {JP}_{l}^{2} = {\sum }_{i ∈ {ID}_{l}} {r}_{i}^{2} {I}_{t , i} \\ {JN}_{l} = {\sum }_{i ∈ {ID}_{l}} {r}_{i} {I}_{t , i} if log ( {q}_{l} ) > δ and {JN}_{l}^{2} = {\sum }_{i ∈ {ID}_{l}} {r}_{i}^{2} {I}_{t , i} \\ {JJ}_{l} = {\sum }_{i ∈ {ID}_{l}} {r}_{i} ( 1 - {I}_{t , i} ) + {\sum }_{i ∈ {IQ}_{l}} {r}_{i} {I}_{t , i} and {JJ}_{l}^{2} = {\sum }_{i ∈ {ID}_{l}} {r}_{i}^{2} ( 1 - {I}_{t , i} ) + {\sum }_{i ∈ {IQ}_{l}} {r}_{i}^{2} {I}_{t , i} with \\ {IQ}_{t} = \{ \begin{matrix}{ID}_{t} & if \vert log ( {q}_{l} ) \vert \leq δ \\ φ & if \vert log ( {q}_{l} ) \vert > δ \end{matrix} \qquad ( 7 )$$

Thus, for each interval, we have associated the total jumps for a positive bubble, a negative bubble, and no bubble. The parameter δ ensures that a jump is not too close to the normal price.

Then the crash amplitude for the lth interval for a positive bubble is

$${κ}_{l}^{+} = \frac{{JP}_{l}}{ln ( {q}_{l} )}$$

and, for negative bubbles, it is

$${κ}_{l}^{-} = \frac{{JN}_{l}}{ln ( {q}_{l} )}$$

while the continuous component of the quadratic variation is

$$\frac{{JJ}_{l}^{2}}{d}$$

so that the average σ (used in equation (1)) for a d-days interval is

$$σ = \sqrt{\frac{1}{h} {\sum }_{l = 1}^{h} {JJ}_{l}^{2}} .$$

We have that K̅⁺ and K̅⁻ are computed from the average of the κₗ⁺ and κₗ⁻ over those d-days crashes or rallies that occur. The probability of a crash or rally is taken from the counts over when they do occur.

We obtain σ, ρ̅, K̅ separating continuous volatility from jumps defined over d-days intervals.

The crucial issues in applying the method is in testing the convergence and selecting the tuning parameters including:
1. h: The number of intervals.
2. d: the number of days in an interval for estimating the jump size and frequency per interval.
3. α: the significance level 1−exp (−β*).
4. δ: The tolerance for measuring closeness to the normal price.
5. k: the number of days to compute the spot volatility.

Variations in the method are possible but the results obtained below with this parameterization are promising. The most sensitive parameter among the five is the d days. A little experimentation on the historical data rapidly determines an excellent value for d.

We initially assume that σ, ρ̅, K̅ are independent of the mispricing with the exception that, in practice, we have separate ρ̅, K̅ for positive and negative bubbles. In Section 5, we extend the model by assuming that ρ is a function of the mispricing ln(q) and/or r̅ₜ resulting in even stronger super-exponential acceleration and finite time singularities.

We estimate the normal price rate r_{N} by calibrating a pure exponential price dynamic over a large time window. Ideally, that time window is prior to the beginning of the bubble. It is a window of time when the stochastics of the price process are relatively stable. In experiments, we have generally used 5 to 15 years. This embodies the longer-term price process. The rate r_{D} is the rate for the short-term component of the price. In experiments, we have estimated it over a window of time prior to the current time, t₂, for a period of 0.5 to 3 years. We do not index these rates by time here for ease of exposition but in practice estimate them at every d-days interval. In a simplified version of the bubble model, we may take r_{N}=r_{D}.

### Exemplary Method to Estimate Crash or Rally Probabilities when Prices are Accelerating

We assume σ is constant. Alternatively, if we allow it to vary, we assume that it is bounded.

Now we assume that the probability of a crash is a function of the mispricing, ρ(qₜ), and seek to estimate the functional form.

We have the actual return

$${r}_{t} = ln ( \frac{{p}_{t + 1}}{{p}_{t}} ) = \overline{{r}_{t}} + {σɛ}_{t} ,$$

and with the RE condition (3) that

$$\begin{matrix}{r}_{t} = \overline{{r}_{t}} + {σɛ}_{t} \\ = {r}_{D} - \frac{\overline{ρ} \overline{K} ln ( {q}_{t} )}{1 - \overline{ρ}} + {σɛ}_{t}\end{matrix} \qquad ( 8 )$$

We assume a parametric form for the probability as a function of the mispricing for a positive bubble (q<1) and for a negative bubble (q>1) of the form:

$$ρ ( q ) ≡ \{ \begin{matrix}\frac{1 - {q}^{a}}{1 + b} b > - 1 & \begin{matrix}if q < 1 ⇒ a > 0 \\ if q > 1 ⇒ a < 0\end{matrix}\end{matrix} \qquad ( 9 )$$

For a positive or negative bubble, we have 0<q^{a}≤1 and a ln(q)≤0 ∇a as given above.

If we have −1<b<0, we define ρ(q)≡1 for q^{a}≤−b. The case −1<b<0 results in a finite time singularity. This is because when the denominator is <1, the numerator can attain the value of the denominator with finite mispricing and thus in finite time. For a value of ρ=1, r̅ₜ becomes infinite through the RE equation. However, that never occurs as the crash probability converges to one and the price crashes before r̅ₜ becomes infinite.

This parametric form illustrates one such form and is not meant to limit our method to the use of this specific form. Many modifications to the depicted form may be made without departing from the spirit and scope of the disclosed embodiments.

This family of functions provides a wide range of monotone accelerating probability functions associated with the mispricing and accelerating expected returns.

Define the two-parameter function of q

$$\begin{matrix}{\overline{r}}_{t} = {R}_{t}^{a , b} ( {q}_{t} ) \\ where & ( 10 ) \\ \begin{matrix}{R}_{t}^{a , b} ( {q}_{t} ) ≡ {r}_{D} - \frac{{ρ}_{t} \overline{K} ln ( {q}_{t} )}{1 - {ρ}_{t}} \\ = {r}_{D} - \frac{( 1 - {q}_{t}^{a} )}{{q}_{t}^{a} + b} \overline{K} ln ( {q}_{t} )\end{matrix} & ( 11 )\end{matrix}$$

where

$${q}_{t} = \frac{{N}_{t}}{{p}_{t}} .$$

We drop the subscript t and superscript a,b and consider R as a function of q: R(q). The following Proposition summarizes important properties of ρ and R(q).

Having obtained a parameterized probability function at each time, if −1<b<0, then we can obtain a crash probability distribution up to the finite time of a crash, t_{c}, when ρ goes to 1.

If we could measure r̅ₜ, we could compute ρₜ directly from Eq. 3. Along with the observable prices, we assume that the parameters r_{D}, r_{N}, K̅, qₜ are known and define:

$${d}_{t} ≡ ln ( {p}_{t + 1} ) - ln ( {p}_{t} ) - {r}_{D} + \frac{( 1 - {q}_{t}^{a} )}{{q}_{t}^{a} + b} \overline{K} ln ( {q}_{t} ) \qquad ( 12 )$$

We propose to calibrate the parameters a and b of the probability function (12) using weighted least squares:

$${Min}_{a , b} {F}_{{t}_{2}} ( a , b ) ≡ \frac{1}{2} {\sum }_{t ∈ Ω ( {t}_{2} )} {w}_{t}^{2} {d}_{t}^{2} \\ Ω ( {t}_{2} ) ≡ \{ t \vert {t}_{1} < t \leq {t}_{2} ∋ \vert ln ( {q}_{t} ) \vert > β and ln ( {q}_{t} ) has the same sign \} \\ {w}_{t} = \vert ln ( {q}_{t} ) \vert \\ a > 0 for a positive bubble and < 0 for a negative bubble \\ b > - 1 \qquad ( 13 )$$

We define t₁ as the beginning of a bubble when ln(qₜ) is close to zero and t₂ the time when the probability is being estimated (i.e. “present” time). In practice, Ω consists of those time periods in a bubble where |ln (qₜ)| is sufficiently large as defined by the parameter β. The reason for β and the weights wᵢ is that the fit improves as |ln(qₜ)| gets large, i.e. when a bubble is well underway. The solution (a, b) gives us the probability of a crash at time t since

$$ρ ( {q}_{t} ) = \frac{1 - {q}_{t}^{a}}{1 + b} \qquad ( 14 )$$

### Exemplary Method to Obtain Asset Price Allocations

The particular values and configurations discussed in these non-limiting examples can be varied and are cited merely to illustrate at least one embodiment and are not intended to limit the scope thereof.

Let be the fraction of wealth wₜ allocated to the risky asset in time t and 1−λₜ the allocation to the risk-free asset with return r_{f}. Then

Wₜ₊₁=exp(λₜ exp(āₜ+σεₜ)+(1−λₜ)exp(r_{f}))Wₜ (15)

where āₜ has been defined in (1). We wish to determine

$${max}_{{λ}_{t}} {E}_{t} [ ln ( \frac{{W}_{t + 1}}{{W}_{t}} ) ] ≡ L ( {λ}_{t}^{*} ) .$$

where Eₜ is the expectation conditional on the information up to time t.

We could resort to estimating L(Δₜ) via a Taylor expansion as in (Levy and Markowitz, 1979). Rather, we may optimize it over a region on which it is concave.

The many asset and liability case can be expressed among other ways as:

$${W}_{t + 1} = ( {\sum }_{i} {λ}_{i , t} exp ( \frac{{ds}_{i} ( t )}{{s}_{i} ( t )} ) ) {W}_{t} \\ \frac{{ds}_{i} ( t )}{{s}_{i} ( t )} = {μ}_{i} ( s , t ) dt + {h}_{i} ( s , t ) dt + {\sum }_{j} {b}_{ij} ( s , t ) {σ}_{j} ( s , t ) d {ω}_{j} ( t ) \qquad ( 16 )$$

Where μᵢ is the usual expected value adjusted for jumps, hᵢ is a jump process, b_{i,j} is the relationships between two assets or liabilities, and dωⱼ(t) is a stochastic distribution including jumps and is therefore is not necessarily a normal distribution. The particular expression in Eq. 16 can be varied to include multiple assets and liabilities together satisfying stochastic processes with jumps that are not generated from normal distributions and is cited merely to illustrate at least one embodiment and is not intended to limit the scope thereof or the spirit of this invention.

### Exemplary Method to Obtain Marginal Returns and Percentage Change in Allocations

The particular values and configurations discussed in these non-limiting examples can be varied and are cited merely to illustrate at least one embodiment and are not intended to limit the scope thereof.

Let aᵢ represent the marginal return on one unit of asset i. Let xᵢ represent the number of units of asset i acquired. Let us assume that the marginals are such that

$${\sum }_{i} {a}_{i} = d ,$$

which can be positive or negative. Let us put a limit on the amount that can be acquired as it may otherwise be infinite. We express that limit as

$$\frac{1}{2} {\sum }_{i} {x}_{i}^{2} \leq M .$$

Then we wish to solve the problem of adjusting a portfolio to maximize the marginal return as:

$${MAX}_{{x}_{i}} {\sum }_{i = 1}^{n} {a}_{i} {x}_{i}$$

$${\sum }_{i} {a}_{i} = d$$

$${\sum }_{i} {x}_{i} = 0$$

$$\frac{1}{2} {\sum }_{i} {x}_{i}^{2} \leq M$$

This has a dual given by aᵢ=u₁+u₂xᵢ ∇i with u₂>0. Then

$${x}_{i} = \frac{{a}_{i} - {u}_{1}}{{u}_{2}} .$$

Since the xᵢ must sum to zero, we have

$${u}_{1} = \frac{d}{n} .$$

Since the sum of the squares of the xᵢ must equal M, we have

$${u}_{2} = \sqrt{\frac{1}{2 M} {\sum }_{i}^{n} {( {a}_{i} - \frac{d}{n} )}^{2}} .$$

Without loss of generality, we can pick M so that u₂=1. Thusly we have the optimal return is generated by picking

$${x}_{i} = {a}_{i} - \frac{d}{n}$$

or any multiple of this via adjusting M.

### How Operates

The method should be run periodically on data that one is interested in or invested in. Periodically can be every two to four weeks or if circumstances change significantly in the markets. If one is using the method as described in FIG. 1, then the parameters (3, 4, 5 and 6) should be adjusted so the efficient portfolio outperforms the asset (See flowchart FIG. 7 and resulting graph FIG. 3)). In this way the method is calibrated. Otherwise, if the method is run in the background the calibration may be done automatically. We by no means rule out the possibility that additional parameters may be included in the calibration of the method as determined in future runs or in specific circumstances or markets. The outputs should include the graphs as in FIG. 3 and details as in FIG. 6. When examining the details in FIG. 6, one should focus on the crash/rally probability and the expected crash/rally size. The hedge component indicates how to optimally hedge the asset in case of a crash or rally indicating the amount to invest in the asset versus the risk-free rate. When the value is 2, for example, it means short the risk-free rate 100% of the value of the portfolio and invest in the asset. When the value is −1, it means short the asset 100% and invest that in the risk-free rate. In this way the resulting portfolio is expected to perform optimally over time while mitigating crashes and advantaging rallies.

### SUMMARY/CONCLUSIONS

The method may be implemented within any programming language, for any computer, and with variations in the user interfaces (FIG. 5) or in the outputs described in FIGS. 8, 9, and 10 or in the data inputs FIG. 6 and FIG. 7. But all alternatives adhere to the intent and spirit of the underlying mathematics described. The mathematical method for the optimization or for the computation of lambda is susceptible of modification and change without departing from the spirit of my invention. The same is true for the separation of jumps and random walk components and of the computation of the dynamic probability in Eq. 14.

The method described herein for hedging crashes and advantaging rallies is unique and nonobvious in its inclusion of the following elements through an equation such as the one called the Rational Expectation Condition and exemplified in Eq. 2:
A method for selecting historical prices and indicators;
A Rational Expectations equation;
A method to obtain a normal price;
A method to obtain historical price and indicator distributions including jump sizes relative to the normal price and probabilities;
A method to estimate future crash and rally sizes relative to a normal price and corresponding probabilities for prices and indicators;
A method to use the crash and rally distributions and historical distributions to obtain an asset and liability allocation that substantially outperforms other methods of asset and liability allocation;
A method to compute zero-sum allocations to adjust a portfolio to improve its performance using the crash and rally distributions.

Many modifications to the mentioned and depicted environments may be made without departing from the spirit and scope of the invention consisting of inclusion of the above listed elements.

None of the disclosed patents nor any of the references include these elements in the manner described herein.

### REFERENCES CITED HEREIN

Andruszkiewicz, G, M. Davis And S. Lleo. 2017. “Risk-Sensitive Investment in a finite-factor model”, Stochastics 89, 89-114.
Ardila-Alvarez, Diego, Zalan Forro and Didier Sornette, The Acceleration effect and Gamma factor in Asset Pricing, Swiss Finance Institute Research Paper No. 15-30. Available at SSRN: http://ssrn.com/abstract=2645882, 2016.
Brunnermeier, M. K. and M. Oehmke, 2013. Bubbles, financial crises, and systemic risk. Handbook of the Economics of Finance, Chapter 18, Elsevier B.V., 1221-1288.
Davis, M and S. Lleo. 2015a. Jump-Diffusion Asset-Liability Management Via Risk-Sensitive Control. OR Spectrum 37, 655. doi: 10.1007/s00291-014-0371-x
Davis, Mark H. A. and Sebastien Lleo. 2015b. Risk-Sensitive Investment Management, World Scientific Publishing Co. Pte. Ltd., Singapore.
Evanoff, Douglas D.; George G. Kaufman; and A. G. Malliaris editors. 2012. New Perspectives on Asset Price Bubbles: Theory, Evidence, and Policy, Oxford University Press, New York.
Jacquier, Eric and Cedric Okou. 2014. “Disentangling Continuous Volatility from Jumps in Long-Run Risk-Return Relationships”, Journal of Financial Econometrics 12 (3), 544-583.
Johansen, Anders, and Didier Sornette, 2001/2002, Large stock market price drawdowns are outliers, Journal of Risk 4, 69-110.
Kelly, J. R. 1956. “A New Interpretation of Information Rate”, Bell Systems Technical Journal, 35, 917-926.
Lin, L. And D. Sornette. 2013. “Diagnostics of Rational Expectation Financial Bubbles with Stochastic Mean-Reverting Termination Times”, The European Journal of Finance 19 (5-6) 344-365.
Malevergne Yannick and Didier Sornette, 2001. Multi-dimensional Rational Bubbles and fat tails, Quantitative Finance 1, 533-54.
MacLean, L. C.; Edward 0. Thorp; and W. T. Ziemba. 2010a. The Kelly Capital Growth, Investment Criterion: Theory and Practice, World Scientific Handbook in Financial Economic Series, World Scientific Publishing C. Pte. Ltd., Singapore.
Meltzer, Allan H. 2002. “Rational and Irrational Bubbles”, Keynote address for the Federal Reserve Bank of Chicago—World Bank Conference on Asset Price Bubbles, Chicago, April 23.
Merton, Robert C. 1990. Continuous-Time Finance, Blackwell Publishers Inc., Cambridge, Mass.
Scherbina, Anna. 2013. “Asset Price Bubbles: Selective Survey,” IMF Working Paper, WP/13/45, IMF Washington, DC.
Sornette, D. 2009. “Dragon-Kings, Black Swans and the Prediction of Crises”, International Journal of Terraspace Science and Engineering 2 (1), 1-18 (http://ssrn.com/abstract=1470006)
Sornette, D. and P. Cauwels. 2015. “Financial bubbles: mechanisms and diagnostics”, Review of Behavioral Economics 2 (3), 279-305.
Tauchen, George and Hao Zhou. 2011. “Realized jumps on financial markets and predicting credit spreads”, Journal of Econometrics, 160, 102-118.
Yan, Wanfeng; Reda Rebib; Ryan Woodard; Didier Sornette. 2012. “Detection of Crashes and Rebounds in Major Equity Markets”, International Journal of Portfolio Analysis & Management (IJPAM) 1(1), 59-79. io Analysis & Management (IJPAM) 1(1), 59-79.
Yan, Wanfeng; Ryan Woodard and Didier Sornette. 2010b. “Inferring Fundamental Value and Crash Nonlinearity from Bubble Calibration”, Quantitative Finance 14 (7), 1273-1282, 2014.
Ziemba, William T. 2003. The Stochastic Programming Approach to Asset, Liability, and Wealth Management, The Research Foundation of AIMR.

I claim:

1. A method for managing an asset price by hedging downturns or advantaging upturns, comprising:
a. providing a predetermined history of said asset prices and a predetermined history of another comparative asset prices, and
b. a method to estimate a normal price such that said asset price oscillates around said normal price, and
c. a method to estimate said asset price jump sizes and probabilities relative to said normal price from said predetermined history of said asset prices and to separate said asset jump sizes from continuous volatility of said asset prices, and
d. a method to estimate a crash or rally probability of said asset price when said asset price is accelerating up or down, and
e. a method to obtain an allocation between said asset and said comparative asset that includes said asset price history, said normal price, said asset price jump sizes, and said crash or rally probability of said asset price and size and probability of said asset price when said asset prices are accelerating up or down, and said comparative asset price history,
whereby the total price of said allocation substantially exceeds probabilistically said asset price.

2. The method of claim 1 wherein said method to obtain an allocation between said asset and said comparative asset includes a method to estimate a predetermined expected value for said asset price, whereby said predetermined expected value improves probabilistically the total price of said allocation substantially exceeding probabilistically said asset price.

3. The method of claim 1 further including an estimate of the crash or rally size of said asset price relative to said normal price, its probability of occurrence, and an amount to invest in the asset versus said comparative asset to obtain a substantial overall return probabilistically, and a method for obtaining information that can be acted upon to improve substantially the return of said allocation over the said asset price alone.

4. The method of claim 1 wherein said comparative asset is a risk-free asset.

5. The method of claim 1 wherein said normal price is a fundamental price.

6. The method of claim 1 wherein said method further includes a computer and a programming language wherein said method is programmed.

7. The method of claim 1 wherein method is repeated over several repetitions of said asset price history and said comparative asset price history to find the combination of said method to estimate normal price, said method to estimate said asset price jump sizes and probabilities relative to said normal price, said method to estimate a crash or rally probability of said asset price, and said method to obtain an allocation between said asset and said comparative asset, whereby the method having the greatest value of said allocation between said asset and said comparative asset is used for hedging said asset price downturn or advantaging its upturn in the next time period whereby said allocation substantially improves the return of said asset price alone.

8. A method for managing a plurality of asset prices including hedging downturns or advantaging upturns, comprising:
a. providing a predetermined history of said plurality of asset prices, and
b. a method to estimate a normal price for each said plurality of asset price such that each said asset price oscillates around each said normal price respectively, and
c. a method to estimate for each said plurality of asset price jump sizes and probabilities relative to each said plurality of normal prices respectively from said predetermined history of said plurality of asset prices and to separate each said asset jump sizes from continuous volatility of each said asset prices, and
d. a method to estimate a crash or rally probability of each said plurality of asset prices when each said asset price is accelerating up or down, and
e. A method to estimate a correlation for each said plurality of asset price jump sizes with respect to each other said asset price jump size, and
f. a method to obtain an allocation between said plurality of assets that includes said asset price predetermined histories, said normal prices, said asset price jump sizes, and said crash or rally probability of said asset prices and size and probability of said asset prices when said asset prices are accelerating up or down, and said correlations for each said asset price jump size with respect to each other said asset price jump size,
whereby the total price of said allocation substantially exceeds probabilistically an equally weighted plurality of said asset prices.

9. The method of claim 9 wherein said method to obtain an allocation between said plurality of assets includes a method to estimate a predetermined expected value for each plurality of said asset prices, whereby said predetermined expected value for each plurality of said asset prices improves probabilistically the total price of said allocation substantially exceeding probabilistically said equally weighted plurality of said asset prices.

10. The method of claim 9 further including an estimate of the crash or rally size of said plurality of asset prices relative to said normal price, said probability of occurrence of each of said plurality of asset prices, and an amount to invest in each of said plurality of assets to obtain a substantial overall return probabilistically of said plurality of asset prices, and a method for obtaining information that can be acted upon to substantially improve the said allocation probabilistically over an equally weighted plurality of said asset prices.

11. The method of claim 9 wherein said plurality of normal prices are a plurality of fundamental prices respectively.

12. The method of claim 9 wherein said method further includes a computer and a programming language wherein said method is programmed.

13. The method of claim 9 wherein method is repeated over several repetitions of said plurality of asset price histories to find the combination of said methods to estimate said plurality of normal prices, said method to estimate said plurality of asset price jump sizes and probabilities relative to said plurality of normal prices, said method to estimate a crash or rally probability of said plurality of asset prices, and said method to obtain an allocation between said plurality of assets, whereby the method having the greatest value of said plurality of allocations is used for hedging said asset plurality of price downturns or advantaging their upturns in the next time period whereby said allocation substantially improves the return of said asset prices over an equally weighted plurality of said asset prices.

14. The method of claim 9 wherein a marginal return for each of said plurality of assets is estimated such that each of said plurality of marginal return estimations is used to estimate a percentage change in said allocation of each of said plurality of assets such that the total of said percentage changes in said plurality of assets sums to zero whereby any of the said plurality of assets purchased with said positive percentage change is financed by said plurality of assets sold with said negative percentage change.
